(19) United States
(12) Patent Application Publication
(10) Pub. No.: US 2025/0294657 A1
(43) Pub. Date: Sep. 18, 2025

(54) LAMP AND LIGHT SOURCE CONTROL METHOD THEREOF

(71) Applicant: LEOTEK CORPORATION, Taipei City (TW)

(72) Inventors: Hai-Tao CHIN, Taipei City (TW); Wei-Ting Wu, Taipei City (TW); Jhao-Tian PAN, Taipei City (TW); Kuo-Yang CHEN, Taipei City (TW)

(21) Appl. No.: 18/796,352

(22) Filed: Aug. 7, 2024

(30) Foreign Application Priority Data
Mar. 12, 2024 (CN) 202410277142.6

(51) Int. Cl. H05B 47/105; H05B 45/10

(52) U.S. Cl. CPC H05B 47/105; H05B 45/10

(57) ABSTRACT

A lamp includes a controller, a plurality of light-emitting devices and a plurality of current conversion modules. The controller is configured to output a dimming signal, which is adjusted according to at least one weather factor. The current conversion modules are coupled to the light-emitting devices and configured to generate a current signal according to the dimming signal to control the light-emitting devices, wherein the dimming signal is related to a visible light including a red light or an infrared light emitting characteristic of the light-emitting devices.

This application claims the benefit of People's Republic of China application Serial No. 202410277142.6, filed Mar. 12, 2024, the subject matter of which is incorporated herein by reference.

### BACKGROUND OF THE INVENTION

### Field of the Invention

The invention relates to a lamp and a light source control method thereof.

### Description of the Related Art

Current street lamps encounter the following problems: 1. only visible light LED light panels are installed in the street lamps. However, visible light has poor water vapor permeability, making it impossible to provide sufficient visibility for self-driving lenses, surveillance equipment or users when visibility is poor at night. 2. There is no infrared LED light panel installed in the street lamps, and only visible light band is provided. As a result, it is difficult for the infrared imaging device of self-driving cars to obtain sufficient infrared intensity at night, making it impossible to clearly identify objects.

### SUMMARY OF THE INVENTION

The present invention relates to a lamp and a light source control method thereof to improve the problems of conventional street lamps.

According to one aspect of the present invention, a lamp including a controller, a plurality of light-emitting devices and a plurality of current conversion modules is provided. The controller is used to output a dimming signal, which is adjusted according to at least one weather factor. The current conversion modules are coupled to the light-emitting devices and used to generate a current signal according to the dimming signal to control the light-emitting devices to emit light, wherein the dimming signal is related to a visible light including a red light or an infrared light emitting characteristic of the light-emitting devices.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a functional block diagram of a street lamp according to an embodiment of the present invention.

FIG. 2 is a flow chart of a light source control method for a street lamp according to an embodiment of the present invention.

FIG. 3 further illustrates a specific embodiment of the light source control method of the street lamp.

### DETAILED DESCRIPTION OF THE INVENTION

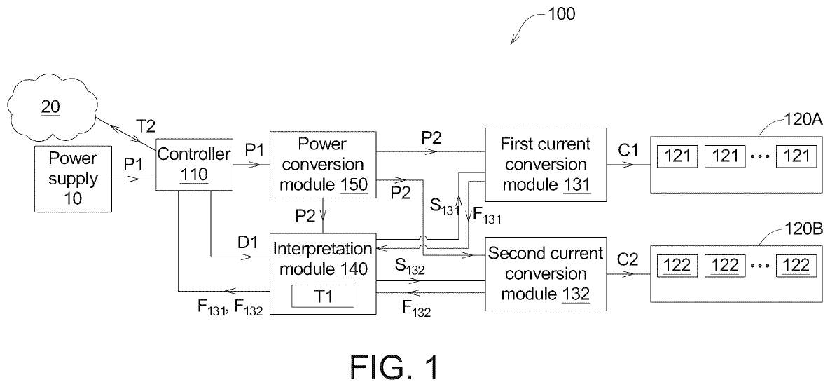

Referring to FIG. 1, a functional block diagram of a street lamp 100 according to an embodiment of the present invention is shown. The street lamp 100 in this embodiment is, for example, a lighting light on a general road, an expressway, or a highway. The street lamp 100 can be configured in urban areas, suburbs or various places that require lighting.

The street lamp 100 may include a controller 110, a plurality of light-emitting devices (for example, at least one first light-emitting device 121 and at least a second light-emitting device 122), several current conversion modules (for example, a first current conversion module 131 and a second current conversion module 132) and an interpretation module 140.

The controller 110 is used to output a dimming signal D1. The current conversion module is coupled to the light-emitting devices and used to control the light-emitting devices to emit light. The interpretation module 140 is coupled to the current conversion modules and is used to output a plurality of control signals (for example, a first control signal S131 and a second control signal S132) corresponding to the dimming signal D1 according to a comparison table T1 to the current conversion modules respectively (for example, the first current conversion module 131 and the second current conversion module 132). The light-emitting devices have different visible lights (including a red light) or an infrared light emitting characteristic. In this way, through the combination of light-emitting devices, a variety of lighting of different light-emitting modes can be emitted to cope with multiple or changing external weather factors.

In detail, the street lamp 100 further includes at least one sensor (not shown). The sensor is electrically coupled to the controller 110, or transmits sensing signals back to the cloud server 20. The sensor detects external weather factors. The external weather factors include, for example, weather (such as rainy days, sunny days, cloudy days, foggy days, etc.), time periods (such as day or night, etc.) or road conditions (such as whether there is snow/water accumulation), etc.

In this embodiment, the controller 110 is, for example, a smart controller of a lamp, which is, for example, a physical circuit formed by a semiconductor process. The controller 110 outputs a corresponding dimming signal D1 to the interpretation module 140 according to the external environment state. In another embodiment, the cloud server 20 can send a dimming command T1 to the controller 110, and the controller 110 outputs a corresponding dimming signal D1 to the interpretation module 140 according to the dimming command T1. After receiving external climate information (for example, provided by a third-party weather website, rainfall sensor, heavy fog sensor), the cloud server 20 can perform intelligent analysis, prediction and record real-time climate information, and then output a dimming command T1 to the controller 110, and the controller 110 outputs the dimming signal D1 to the interpretation module 140. The interpretation module 140 can output the first control signal S₁₃₁ and the second control signal S₁₃₂ corresponding to the dimming signal D1 to the first current conversion module 131 and the second current conversion module 132 respectively according to the comparison table T1. The current conversion module 131 outputs a first current signal (for example, a first direct current C1) corresponding to the first control signal S₁₃₁ to the first light-emitting device 121, and the second current conversion module 132 outputs a second current signal corresponding to the second control signal S₁₃₂ (for example, a second direct current C2) to the second light-emitting device 122, so that the first light-emitting device 121 and the second light-emitting device 122 emit light corresponding to the external weather factors. The aforementioned first control signal S₁₃₁ and second control signal S₁₃₂ are, for example, pulse-width modulation (PWM) signals.

It can be seen that the present invention can be controlled through the cloud artificial intelligence (AI) platform. The interpretation module 140 outputs the control signal corresponding to the dimming signal D1 to each current conversion module, thereby adjusting the first light panel 120A (i.e., a visible light lamp panel) and the second light panel 120B (i.e., an infrared light lamp panel) to adapt to the ambient climate and thereby output an optimal lamp spectrum.

As shown in FIG. 1, the first light-emitting devices 121 and the second light-emitting devices 122 are, for example, light-emitting diodes, laser diodes, or other light-emitting devices suitable for the street lamp 100. The first light-emitting devices 121 and the second light-emitting devices 122 are different in visible light (including a red light) or infrared light emitting characteristics. Although the embodiment of the present invention uses one light-emitting device with the same red light or infrared light emitting characteristic as an example, in other embodiments, there can be two or more light-emitting devices with the same red light or infrared light emitting characteristics. The first light-emitting device 121 and the second light-emitting device 122 have different red light energies. In one embodiment, the red light energy of the first light-emitting device 121 is higher than the red light energy of the second light-emitting device 122 (the infrared light-emitting device has no red light component). Specifically, the first light-emitting device 121 is, for example, a visible light-emitting device, and the second light-emitting device 122 is, for example, an infrared light-emitting device. The aforementioned “visible light” is, for example, the light in the visible light band range of 380 nm-780 nm, and the aforementioned “infrared ray” is, for example, the light in the infrared band range of 760 nm-1000 nm, but the present invention is not limited thereto. Since the red light component of visible light (in the band range of 620 nm to 780 nm) only accounts for less than 21% of all visible light energy, it cannot provide sufficient visual distance for self-driving cars when visibility is poor at night. Therefore, embodiments of the present invention increase the red light component in visible light or add additional infrared light-emitting devices, so that the self-driving car can obtain sufficient red light component at night and obtain sufficient infrared energy in rainy and foggy weather to clearly identify objects.

In one embodiment, increasing the red light component in visible light is, for example, increasing the content of red phosphor in the light-emitting device, so that the red light component in visible light could be between 21% and 30%. Adding additional infrared light-emitting devices, such as adding infrared light panels to street lamps, can increase the energy of infrared rays.

As shown in FIG. 1, the lamp 100 further includes at least one light panel, and each light panel can carry at least one light-emitting device or at least two light-emitting devices with the same light-emitting characteristics. For example, the lamp 100 further includes a first light panel 120A and a second light panel 120B. At least one first light-emitting device 121 with the same red light or infrared light emitting characteristic can be configured on the first light panel 120A, and at least one second light-emitting device 122 with the same light-emitting characteristics can be disposed on the second light panel 120B. Each light panel can be coupled to a corresponding current conversion module to be controlled by the corresponding current conversion module. For example, the first lamp panel 120A is coupled to the first current conversion module 131, and the second lamp panel 120B is coupled to the second current conversion module 132.

As shown in FIG. 1, each current conversion module (the first current conversion module 131 and the second current conversion module 132) is, for example, a physical circuit formed by a semiconductor process, which is used to output a direct current to the corresponding light-emitting device (or light panel) according to the corresponding control signal, where the direct current is determined according to the comparison table T1. For example, the first current conversion module 131 outputs a first current signal (first direct current C1) to the first light-emitting device 121 according to the first control signal S₁₃₁. The first light-emitting device 121 is driven by the first direct current C1 to emit light. The second current conversion module 132 outputs a second current signal (second direct current C2) to the second light-emitting device 122 according to the second control signal S₁₃₂. The second light-emitting device 122 is driven by the second direct current C2 to emit light. In addition, the number of current conversion modules is equal to the type of red light or infrared light emitting characteristics of the light-emitting devices, and each current conversion module is coupled to at least one light-emitting device with the same red light or infrared light emitting characteristic.

Each current conversion module outputs direct current to the corresponding light panel according to the corresponding control signal to control the light emitting devices arranged on the corresponding light panel to emit light. For example, the first current conversion module 131 outputs a first current signal (first direct current C1) to the first light panel 120A according to the first control signal S₁₃₁ to control the first light emitting device 121 disposed on the first light panel 120A. The second current conversion module 132 outputs a second current signal (second direct current C2) to the second lamp panel 120B according to the second control signal S₁₃₂ to control the second light emitting device 122 disposed on the second lamp panel 120B to emit light.

The interpretation module 140 is, for example, a physical circuit formed using a semiconductor process, or may be software or firmware, which may be integrated into the controller 110 or another controller or processor. The interpretation module 140 may store the comparison table T1. In one embodiment, the interpretation module 140 executes the following steps: (1) to compare the dimming signal D1 according to the comparison table T1; and (2) to output the control signal corresponding to the dimming signal D1 to the corresponding light-emitting device without executing the voltage-dividing operations and/or current-dividing operations, and/or no signal processing is performed on the dimming signal D1, but this is not intended to limit the embodiments of the present invention.

As shown in FIG. 1, the street lamp 100 further includes a power conversion module 150. The power conversion module 150 is, for example, an AC-to-DC transformer. AC-to-DC transformers have the advantages of being cheap, stable, mature, and highly efficient in conversion. The power conversion module 150 and the interpretation module 140, being placed in the front stage of circuit, can effectively prevent damage to the power conversion module 150 and the interpretation module 140 due to surges. The power conversion module 150 is coupled to the current conversion modules and the interpretation module 140 and is used to provide power to the current conversion modules and the interpretation module 140. For example, the power supply 10 is coupled to the controller 110 and outputs the alternating current P1 to the controller 110. The controller 110 transmits the alternating current P1 to the power conversion module 150. The power conversion module 150 converts the alternating current P1 into direct current P2, and provides the direct current P2 to each current conversion module and the interpretation module 140 according to the needs of each current conversion module and the interpretation module 140. The direct current power P2 required by each current conversion module and the interpretation module 140 may be the same or different.

In addition to using the power supply 10 that provides alternating current P1, a power supply 10 that directly provides direct current can also be used. The controller 110 can transmit the direct current to the power conversion module 150 to provide the direct current P2 required by each current conversion module.

The following describes the relationship between the dimming signal D1, the first control signal S₁₃₁, and the second control signal S₁₃₂.

As shown in Table 1 below (Comparison Table T1), it lists the relationship between the mode, climate factors, visibility, first control signal S₁₃₁ and second control signal S₁₃₂ corresponding to the dimming signal D1. The comparison table T1 can be obtained in advance through experiments, simulations, etc., and then stored in the interpretation module 140 or in a storage unit (e.g., memory) coupled to the interpretation module 140. In actual application examples, the mode can have several voltage selections (such as 0-10V) and digital dimming signal D1, which is not limited to 1-5V. Table 1 (Comparison Table T1) is only an example and is not intended to limit the embodiments of the present invention. As can be seen from Table 1, the values of several control signals in the embodiment of the present invention may be equal or different. For example, the control signals are all equal to 0; or, one of the control signals is equal to 0 and the other control signal is not equal to 0. In another embodiment, the values of these control signals may be greater than 0 and equal to each other. In other embodiments, the values of the control signals may not be equal to 0. The numerical values and/or proportional relationships of these control signals may be determined based on external weather factors, and are not limited in the embodiments of the present invention.

TABLE 1
(Comparison Table T1)

| Mode | | | | |
|---|---|---|---|---|
| corresponding | | | First | Second |
| to dimming | | | control | control |
| signal D1 | Weather | Visibility | signal | signal |
| (voltage) | factors | (meters) | S₁₃₁ | S₁₃₂ |
| 0 | clear night | 5000-20000 | 100% | 0% |
| 1 | light rain | 1000-5000 | 100% | 50% |
| 2 | heavy rain | 10-1000 | 100% | 100% |
| 3 | mist | 1000-2000 | 100% | 50% |
| 4 | heavy fog | 10-1000 | 100% | 100% |
| 5 | snow | 100-1000 | 80% | 100% |

Assuming that the dimming signal D1 is 1 Volt (V), the interpretation module 140 outputs the first control signal S₁₃₁ representing 100% of 1V to the first light-emitting device 121 according to the comparison table T1, and outputs the second control signal S₁₃₂ representing 50% of 1V to the second light-emitting device 122. The first light-emitting device 121 emits light according to the first control signal S₁₃₁ and the second light-emitting device 122 emits light according to the second control signal S₁₃₂. The light emission of the first light-emitting device 121, the light emission of the second light-emitting device 122 or their mixed light emission can conform to the external weather factor. As shown in FIG. 1, the first light-emitting device 121 is a light-emitting diode that increases the red light component of visible light. The second light-emitting device 122 is, for example, an infrared light-emitting diode. In sunny weather, the first light-emitting device 121 on the first light panel 120A is turned on, but the second light-emitting device 122 on the second light panel 120B does not need to be turned on. In rainy and foggy weather, in addition to turning on the first light-emitting device 121 on the first light panel 120A, it is also necessary to turn on the second light-emitting device 122 on the second light panel 120B.

It should be noted that on a clear night, due to good visibility, the light emitted by the street lamp can directly reach passengers and the lenses for the vehicle, with less scattering effect. Therefore, based on energy saving, there is no need for output of the second light panel 120B (infrared light panel). That is, the second control signal S₁₃₂ is 0V. In rainy and foggy days, the visibility of visible light is reduced because the air is filled with moisture. In order to increase the amount of light entering the infrared lens for the vehicle, the second light panel 120B (infrared light panel) is allowed to output light depending on the climate factors (that is, the second control signal S₁₃₂ is not 0V), and the infrared ray has better water vapor penetration ability, allowing infrared lenses to achieve better image quality. In addition, in snowy climates, due to the high reflectivity of snow, it is easy to form severe glare. In order to ensure road safety, within the scope permitted by local regulations, the visible light output from the first light panel 120A is reduced to 80% of 5V (i.e., the first control signal S₁₃₁ is 80% of 5V), and turns on the second light panel 120B (infrared light panel) as an auxiliary light for the vehicle lens, thereby improving the visual quality of the vehicle lens.

During the day, the street lamp 100 can emit visible light, which has better luminous efficiency and allows passengers to concentrate and easily identify distant and near objects (such as the shape of objects), and the sun during the day provides enough infrared rays for the infrared lens of the vehicle, so no supplementary infrared ray is required. In rainy or foggy days, the street lamp 100 can emit infrared rays, in which infrared rays have good penetration into rain and fog, and the street lamp 100 increases the output of infrared rays, so that passengers will not feel the change in lighting. Furthermore, if the street lamp 100 increases the blue light device, although the amount of light entering the vehicle lens can be increased, increasing the blue light device will cause color abnormalities, mosquito gathering, high color temperature, affect the physiological state of residents, etc. Therefore, compared with blue light, infrared rays can reduce the impact of lighting on human eyes, the environment and/or ecology, and achieve environmentally friendly purposes.

In addition, the street lamp 100 can also provide abnormality judgment information for the controller 110 or the cloud server 20 to judge the cause of the abnormality. Examples will be further described below.

As shown in FIG. 1, one, any, or each of the current conversion modules can output feedback signals (first feedback signal F131 and second feedback signal F132) to the controller 110. For example, the first current conversion module 131 can output the first feedback signal F₁₃₁ to the controller 110, and the second current conversion module 132 can output the second feedback signal F₁₃₂ to the controller 110. In addition, the feedback signal is transmitted to the controller 110 through the interpretation module 140, for example. However, the embodiment of the present invention is not limited thereto, and the feedback signal can also be directly transmitted to the controller 110. The feedback signal can carry data related to the current input/output of the current conversion modules. For example, the first feedback signal F₁₃₁ represents the current and/or voltage actually output from the first current conversion module 131 to the first light-emitting device 121, and the second feedback signal F₁₃₂ represents the current and/or voltage actually output from the second current conversion module 132 to the second light-emitting device 122. The first current conversion module 131 further includes a detection circuit (not shown), which can detect the current and/or voltage output to the first light-emitting device 121. Similarly, the second current conversion module 132 further includes a detection circuit (not shown) can detect the current and/or voltage output to the second light-emitting device 122.

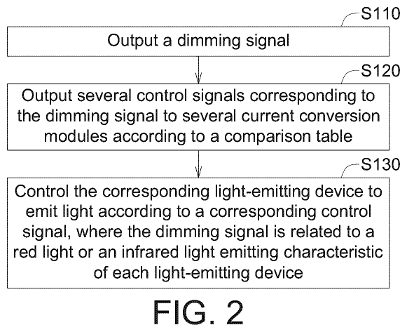

Referring to FIG. 2, a flow chart of a light source control method of the street lamp 100 in FIG. 1 is illustrated. In step S110, the controller 110 outputs the dimming signal D1 to the interpretation module 140. For example, the controller 110 outputs the dimming signal D1 corresponding to the external weather factor to the interpretation module 140, or outputs the dimming signal D1 to the interpretation module 140 according to the dimming instruction T1.

In step S120, the interpretation module 140 outputs several control signals corresponding to the dimming signal D1 to several current conversion modules according to the comparison table T1. The current conversion modules are coupled to the light-emitting devices. For example, as shown in FIG. 1, the interpretation module 140 outputs the first control signal S₁₃₁ corresponding to the dimming signal D1 and the second control signal S₁₃₂ corresponding to the dimming signal D1 to the current conversion module 131 and the second current conversion module 132 respectively according to the comparison table T1.

In step S130, each current conversion module controls the corresponding light-emitting device to emit light according to the corresponding control signal, where the dimming signal D1 is related to a red light or an infrared light emitting characteristic of each light-emitting device. For example, as shown in FIG. 1, the first current conversion module 131 controls the first light-emitting device 121 to emit light according to the first control signal S₁₃₁, and the second current conversion module 132 controls the second light-emitting device 121 to emit light according to the second control signal S₁₃₂. The light emission of the first light-emitting device 121, the light emission of the second light-emitting device 122, or their mixed light emission can generate infrared light that meets the requirements of external weather factors. In this way, through the combination of multiple light-emitting devices with different red light or infrared light emitting characteristics, multiple different light-emitting modes can be emitted to respond to multiple or changing external weather factors.

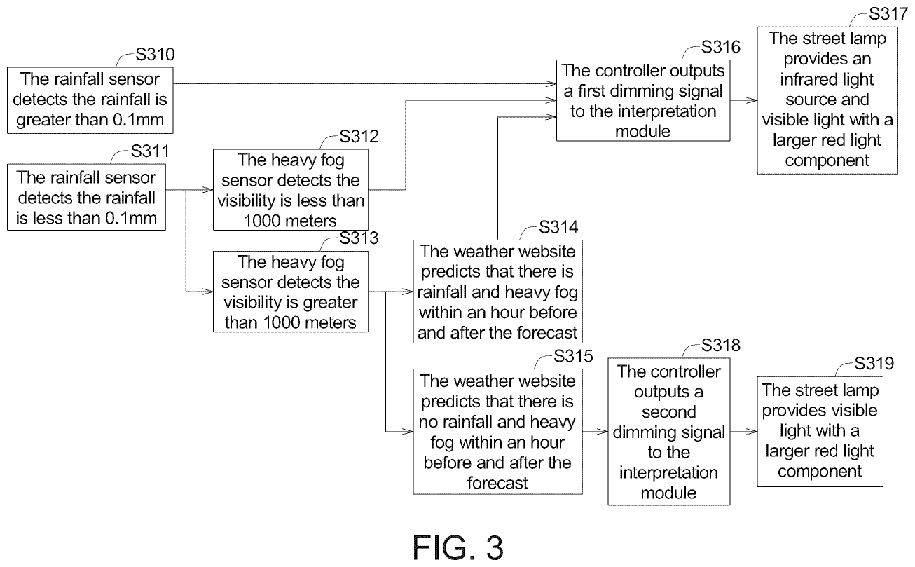

Referring to FIG. 3, a specific embodiment of a light source control method of the street lamp 100 is further illustrated. In FIG. 3, for example, the current climate information is provided through rainfall sensors, heavy fog sensors and external weather websites, and the climate information is sent back to the controller to determine the current climate conditions. After receiving the climate information, the controller can output a dimming signal to the interpretation module 140 based on rainfall, visibility and/or weather forecast reports. As shown in FIG. 3, when the rainfall sensor detects the rainfall is greater than 0.1 mm (step S310) or the rainfall sensor detects the rainfall is less than 0.1 mm (step S311) but the heavy fog sensor detects the visibility is less than 1000 meters (step S312), or when the rainfall sensor detects that the rainfall is less than 0.1 mm (step S311) and the heavy fog sensor detects that the visibility is greater than 1000 meters (step S313), but the weather website predicts that there is rainfall and heavy fog within one hour before and after the forecast (step S314), the controller outputs a first dimming signal to the interpretation module 140 (step S316), so that the street lamp 100 provides an infrared light source and visible light with a larger red light component (step S317). On the contrary, when the rainfall sensor detects that the rainfall is less than 0.1 mm (step S311), the heavy fog sensor detects that the visibility is greater than 1000 meters (step S313), and the weather website predicts that there is no rainfall and heavy fog within one hour before and after the forecast (step S315), the controller 110 outputs a second dimming signal to the interpretation module 140 (step S318), so that the street lamp 100 provides visible light with a larger red light component (step S319), but does not need to provide an infrared light source.

The above-mentioned embodiments of the present invention provide a street lamp and a light source control method thereof. By increasing the red light component in visible light or adding infrared light-emitting devices to the street lamp, the amount of light entering the infrared lens of the vehicle is increased, thereby improving image recognition of the infrared lens of the vehicle.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A lamp, comprising:
a controller for outputting a dimming signal that is adjusted according to at least one weather factor;
a plurality of light-emitting devices;
a plurality of current conversion modules, coupled to the light-emitting devices for generating a current signal according to the dimming signal to control the light-emitting devices to emit light, wherein the dimming signal is related to a visible light including a red light or an infrared light emitting characteristic of the light-emitting devices.

2. The lamp of claim 1, further comprising an interpretation module coupled to the current conversion modules and used to output a plurality of control signals corresponding to the dimming signal according to a comparison table respectively to the current conversion modules.

3. The lamp of claim 2, further comprising a power conversion module, coupled to the current conversion modules and the interpretation module, and used to supply power to the current conversion modules and the interpretation module.

4. The lamp of claim 2, further comprising a plurality of light panels, and the light-emitting devices with a same visible light including the red light or infrared light emitting characteristic are arranged on a same light panel, and each of the current conversion modules is coupled to a corresponding light panel; each of the current conversion modules is used to output a direct current to the corresponding light panel according to a corresponding control signal to control the light emitting devices disposed on the corresponding light panel to emit light.

5. The lamp of claim 1, wherein the light-emitting devices increase the visible light including the red light or the infrared light emitting characteristic by increasing a red light component in visible light or adding infrared light-emitting devices.

6. A light source control method for a lamp, comprising:
outputting a dimming signal that is adjusted according to at least one weather factor; and
generating a current signal according to the dimming signal to control a plurality of light-emitting devices to emit light, wherein the dimming signal is related to a visible light including a red light or an infrared light emitting characteristic of the light-emitting devices.

7. The light source control method of claim 6, further comprising outputting a plurality of control signals corresponding to the dimming signal to a plurality of current conversion modules according to a comparison table, wherein the current conversion modules are coupled to the light-emitting devices.

8. The light source control method of claim 7, further comprising outputting a direct current to a corresponding light-emitting device according to a corresponding control signal by each of the current conversion modules.

9. The light source control method of claim 1, wherein the light-emitting devices increase the visible light including the red light or the infrared light emitting characteristics by increasing a red light component in visible light or adding infrared light-emitting devices.

10. The light source control method of claim 1, wherein the at least one weather factor comprises at least one of rainfall, visibility, weather forecast reports on rainy or foggy days.
